(19) United States
(12) Patent Application Publication
(10) Pub. No.: US 2007/0163883 A1
(43) Pub. Date: Jul. 19, 2007

(54) Microfluidic system comprising an electrode arrangement and associated control method

(75) Inventors: Thomas Schnelle, Berlin (DE); Annette Pfennig, Berlin (DE); Torsten Muller, Berlin (DE)

Correspondence Address: CAESAR, RIVISE, BERNSTEIN,;COHEN & POKOTILOW, LTD., 11TH FLOOR, SEVEN PENN CENTER, 1635 MARKET STREET, PHILADELPHIA, PA, 19103-2212, US

(73) Assignee: Evotec Technologies GmbH, Dusseldorf (DE)

(21) Appl. No.: 10/597,674

(22) PCT Filed: Feb. 3, 2005
(86) PCT No.: PCT/EP05/01084

§ 371 Date: Aug. 3, 2006

(30) Foreign Application Priority Data
Apr. 8, 2004 (DE) 10 2004 017 482.2
Feb. 4, 2004 (EP) PCT/EP04/01031
Feb. 4, 2004 (EP) PCT/EP04/01034

(51) Int. Cl. B03C 5/02

(52) U.S. Cl. 204/547; 204/643

(57) ABSTRACT

The invention relates to a microfluidic system, in particular in a cell sorter, including a first carrier power supply (1) which is used to supply a first carrier flow having particles (4) suspended therein, a first carrier power output line (15) which is used to withdraw at least one part of the carrier flow having particles (4) suspended therein, a process chamber (3) which is used to examine, observe, manipulate and/or select the particle (4). The first carrier power supply (1) flows into the process chamber (3) when the first carrier power output line (15) is discharged from the process chamber (3). According to the invention, at least one second carrier power supply (2) flows into the process chamber (3) in order to supply a second carrier flow having particles (5) suspended therein. The invention also relates to a corresponding operational method.

The invention relates to a microfluidic system, in particular in a particle sorter, in accordance with the preamble of claim 1 as well as to an actuation method for an electrode arrangement in such a microfluidic system in accordance with the preamble of claim 20.

A microfluidic system for investigating biological cells in which the cells to be analyzed are suspended in a carrier flow and manipulated and sorted dielectrophoretically is known from T. MÜLLER et al.: “A 3-D Microelectrode System for Handling and Caging Single Cells and Particles”, Biosensors & Bioelectronics 14 (1999) 247-256. The cells to be analyzed are first aligned in the carrier flow by a funnel-shaped dielectrophoretic electrode arrangement and subsequently retained in a dielectrophoretic cage in order to be able to analyze the cells present in the cage in a resting state, for which microscopic, spectroscopic or optical fluorescence measuring methods can be used. The cells trapped in the dielectrophoretic cage can be subsequently sorted as a function of their analysis, for which the operator actuates a sorting apparatus (“switch”) consisting of a dielectrophoretic electrode arrangement arranged in the carrier flow behind the dielectrophoretic cage. Thus, several manipulating apparatuses are arranged in series in the carrier flow channel in this known microfluidic system that manipulate the particles suspended in the carrier flow.

The known microfluidic system therefore has the disadvantageous fact that a plurality of electrodes must be arranged in the carrier flow channel in order to form the various manipulation apparatuses (e.g., “funnel”, “cage” and “switch”).

The invention therefore has the basic problem of simplifying the previously described, known microfluidic system.

This problem is solved by the features of the independent claims.

The invention comprises the general technical teaching of integrating the functions of various manipulation apparatuses in a single electrode arrangement so that not each manipulation apparatus in the carrier flow channel requires a separate electrode arrangement. In this instance the common electrode arrangement therefore performs various manipulation functions (e.g., trapping and sorting of particles) as a function of its actuation.

Therefore, preferably at least two manipulation apparatuses (e.g., a cage and a switch) are arranged in the carrier flow channel of the microfluidic system of the invention, the two manipulation apparatuses having a common electrode arrangement. The common electrode arrangement of the two manipulation apparatuses can be actuated for carrying out various manipulation functions. For example, the common electrode arrangement can be actuated in such a manner that the particles suspended in the carrier flow are fixed in the electrode arrangement connected as a field cage. However, it is also possible as an alternative that the common electrode arrangement is actuated in such a manner that the particles suspended in the carrier flow are sorted into one of several outlet conduits.

Therefore, in the preferred exemplary embodiment the functions of two manipulation apparatuses are integrated into the common electrode arrangement, namely, the function of a field cage and the function of a sorting apparatus or of a particle gate (“switch”). However, the invention is not limited to these two functions as regards the number of manipulation functions to be integrated in the common electrode arrangement, but rather it is also possible to integrate other manipulation functions or a greater number of different manipulation functions in the common electrode arrangement. In particular, there is the possibility within the framework of the invention to integrate three different manipulation apparatuses in a common electrode arrangement, which three manipulation apparatuses can be, e.g., a field cage, particle gate (“switch”) and a centering apparatus (“funnel”). The construction and method of operation of these manipulation apparatuses is described in the publication, already cited initially, of T. MULLER et al.: “A 3-D Microelectrode System for Handling and Caging Single Cells and Particles”, whose content is to be included to its full extent in the present specification.

Otherwise, the concept of a manipulation apparatus used in the framework of the invention is to be understood in a general manner and not limited to the previously cited types of manipulation apparatuses.

For example, the manipulation apparatus can be a dielectric or dielectrophoretic manipulation apparatus.

Furthermore, the manipulation apparatus could deform the particles (e.g., biological cells) dielectrically in a conventional manner so that the manipulation apparatus could be designated as a deformation apparatus.

Furthermore, there is the possibility in the context of the invention that the manipulation apparatus pores the particles (e.g., biological cells), which is also known. During this, the cell lining is torn open by a high-voltage impulse and thus made permeable. In this instance the manipulation apparatus can also be designated as an electroporation apparatus.

However, the manipulation apparatus in the sense of the invention can also be an apparatus for cellular fusion.

Furthermore there is the possibility within the context of the invention that the manipulation apparatus thermally treats the particles or processes them dielectrophoretically as well as electrophoretically.

The concept of the common electrode arrangement used in the context of the invention is preferably to be understood in such a manner that the common electrode arrangement comprises at least one electrode that is a component of several different manipulation apparatuses.

Furthermore, it should be mentioned that the electrode arrangement of the microfluidic system of the invention can have several electrodes that can differ as regards their shape, length and width.

In the integration of a dielectrophoretic field cage and of a dielectrophoretic particle gate in the common electrode arrangement the common electrode arrangement is preferably arranged in a branching area of the carrier flow channel in which the carrier flow channel branches into several outlet conduits. In this arrangement a common electrode arrangement can be selectively connected as a particle gate or as a field cage, which would be more difficult in another arrangement further upstream in the carrier flow channel. The concept of a branching area of the carrier flow channel used in the context of the invention is to be understood in a general manner and not limited to the point of intersection of the outlet conduits but rather also comprises, e.g., the so-called “separatrix” located upstream before the geometric point of intersection of the output conduit.

In a preferred exemplary embodiment of the invention a dividing line runs in the carrier flow channel, the particles located on the one side of the dividing line flowing without an actuation of the particle gate into the one outlet conduit whereas the particles located on the other side of the dividing line flow without an actuation of the particle gate into the other outlet conduit. The particles to be sorted onto the different outlet conduits must therefore merely be brought onto one side of the dividing line and then flow independently into the provided outlet conduit. This has the advantage that the particle gate can be arranged upstream before the branching area of the outlet conduits and in particular upstream before the geometric point of intersection of the outlet conduits.

The previously cited dividing line can be a real dividing wall that separates two partial flows from one another, the two partial flows each flowing into a determined outlet conduit. However, it is also possible as an alternative that the dividing line is merely an imaginary line or surface between the two partial flows.

In a variant of the invention the particle gate is substantially arranged on the dividing line. The particle gate must therefore always be actively actuated in order to transport the particular particle with sufficient reliability into the provided outlet conduit.

On the other hand, in another variant of the invention the particle gate is arranged relative to the direction of flow in the carrier flow channel laterally next to the dividing line and the particles are supplied to the particle gate preferably by a centering apparatus (“funnel”) located upstream. This has the advantage that the particle gate only has to be actively actuated when a particle is to be deflected over the dividing line in order to pass into the appropriate outlet conduit on the opposite side of the dividing line. On the other hand, if a particle is to flow into the outlet conduit on the side of the particle gate, no active actuation of the particle gate is required. The particle gate can be arranged on the side of the dividing line from which the outlet conduit for negatively selected particles (waste) branches off. However, it is also possible as an alternative that the particle gate is arranged on the side of the dividing line from which the outlet conduit for positively selected particles branches off.

In another exemplary embodiment of the invention the carrier flow channel on the outlet side does not necessarily branch into several outlet conduits. Instead, at least one bypass flow channel runs next to the carrier flow channel, which is preferably separated from the carrier flow channel by a dividing wall, an opening being present in the dividing wall in which opening the particle gate is arranged. Therefore, in this exemplary embodiment only the individual particles are sorted whereas, in contrast thereto, the carrier flows flow further substantially without being influenced. For example, two bypass flow channels can run laterally next to the carrier flow channel that conducts the carrier flow with the particles suspended therein so that the particle gate can selectively transport the particles suspended in the carrier flow into one of the adjacent bypass flow channels.

However, it is not obligatorily necessary in this exemplary embodiment that a physical dividing wall runs between the carrier flow channel and the bypass flow channel but rather it is also possible that the carrier flow channel is separated from the bypass flow channel merely by an imaginary dividing line or dividing surface, wherein the separation of carrier flow and bypass flow is conditioned solely by the flow because carrier flow and bypass flow flow next to one another in a laminar manner.

In an exemplary embodiment of the invention the common electrode arrangement comprises at least one arrow-shaped electrode and several deflection electrodes, the arrow-shaped electrode being aligned in opposite direction to the direction of flow of the carrier flow whereas the deflection electrodes are arranged upstream before the arrow-shaped electrode and border on the arrow-shaped electrode. During the operation as dielectrophoretic particle gate the arrow electrode is permanently activated whereas the deflection into the various outlet conduits takes place by switching the various deflection electrodes. This arrangement of a dielectrophoretic particle gate is also designated as an “Ultra Fast Sorter” (UFS) and makes possible a rapid sorting of the suspended particles. In addition, even this electrode arrangement can be connected as a field cage in order to fix the particles suspended in the carrier flow.

In the preferred exemplary embodiments the common electrode arrangement has six or eight electrodes that can be separately actuated in order to perform the desired manipulation function (e.g., particle fixation or particle sorting). However, the invention is not limited as regards the number of electrodes of the common electrode arrangement to six or eight electrodes but can basically also be realized with other configurations.

In an exemplary embodiment of the invention the field cage consists of eight electrodes whereas the centering unit (funnel) has four electrodes, the four electrodes of the field cage located upstream each being electrically connected to one of the electrodes of the centering unit. Thus, in this instance a field cage and a centering unit are integrated in a common electrode arrangement, wherein the electrodes of the centering apparatus can be actuated in common with the four electrodes of the field cage that are located upstream.

Furthermore, it should be mentioned that the microfluidic system of the invention preferably includes a first measuring station in which the particles suspended in the carrier flow are analyzed in the flowing state upstream from the common electrode arrangement.

This analysis can concern, e.g., the intensity of a fluorescence, the vitality of a cell and/or the question of whether a single cell is involved or an aggregate of several cells. Furthermore, it can be determined in this analysis whether cells or material are involved that are not the primary target of the closer analysis in shape and size, e.g., impurities or other cells, in as far as they differ from the multicells. In addition to geometric parameters, material parameters can also be determined. This can concern, e.g., chemical concentrations that can be measured with fluorescence technology as well as physical parameters such as viscosity and elasticity that can be determined by an evaluation of the deformations and/or relaxations occurring in the electric field. For example, a transmitted-light measurement, a fluorescence measurement and/or an impedance spectroscopy can take place within the context of this analysis. In addition, it is possible that a transmitted-light measurement takes place at first and subsequently a fluorescence measurement, the transmitted-light measurement and the fluorescence measurement preferably taking place in spatially separate regions of interest. The transmitted-light measurement can make it possible, e.g., to distinguish between living and dead biological cells whereas the fluorescence measurement can be used in order to analyze if the particles suspended in a carrier flow carry a fluorescent marker.

If both, a transmitted-light measurement and a fluorescence measurement take place in spatially separate regions of interest in the context of the pre-analysis it is advantageous if the region of interest for the transmitted-light measurement is located upstream before the region of interest for the fluorescence measurement. However, it is also possible as an alternative that the region of interest for the transmitted-light measurement is arranged in the carrier flow downstream behind the region of interest for the fluorescence measurement.

An optical image is preferably taken in the first measuring station in the context of the analysis, which makes possible a digital image evaluation for classifying the particles. The particles are preferably analyzed morphologically in this instance in order to, e.g., be able to distinguish an individual biological cell from a clump of cells. However, the concept of an optical image used in the context of the present specification is to be understood as a general concept and not limited to two-dimensional images in the traditional sense of the words but rather the concept of an optical image in the sense of the invention also comprises a punctiform or linear optical scanning of the carrier flow and/or of the particles suspended in the carrier flow. For example, the brightness along a line transverse to the carrier flow channel can be integrated in order to detect and classify individual particles.

The distinguishing of living and dead cells in the framework of the analysis in the first measuring station can take place in a transmitted-light measurement by evaluating the intensity distribution in the optical image taken. A special principle of this transmitted-light measurement with the cited properties is, e.g., the phase-contrast illumination. Thus, living biological cells have a ring structure with a relatively bright edge and a darker center in the transmitted-light measurement whereas in contrast thereto dead biological cells in a transmitted-light measurement have an approximately uniform brightness and appear dark against the background.

In addition to the analysis of the particles in the first measuring station another measuring preferably takes place in a second measuring station that analyzes the particles fixed in the field cage. The fixation of the particles during the analysis is advantageous since in this manner a substantially more precise analysis is possible.

During the analysis in the second measuring station, e.g., certain molecules can be localized inside a cell. For example, molecules can be localized in the framework of this analysis that are marked with a fluorescent dye.

The fluorescent dye can be, e.g., tags of green fluorescent protein and its derivatives produced by molecular biology and other autofluorescent proteins. However, such fluorescent dyes that bind to a cellular molecule in a covalent or non-covalent manner are also suitable as fluorescent dyes. In addition, even fluorigenic substances can be used as fluorescent dyes that are converted from cellular enzymes into fluorescing products or so-called FRET pairs (fluorescence-resonance energy transfer). The state of the fluorescent dyes used can be distinguished, e.g., using their spectral properties or by bioluminescence.

Even the structure and the function of molecules can be determined using the localization of molecules inside a cell. A distinction can be made in this instance, e.g., according to the occurrence in the plasma membrane, in the cytosol, in the mitochondria, in the Golgi apparatus, in endosomes, in lysosomes, in the cell nucleus, in the spindle apparatus, in the cytoskeleton, colocalization with actin, tubulin.

Furthermore, the morphology of a cell can be determined in the framework of the main and/or pre-analysis in the first or second measuring station and dyes can also be used for this. In addition, even two or more states of a cell population can be distinguished in the framework of the main and/or pre-analysis.

Moreover, it is possible in the framework of the main analysis to determine a cellular signal in the second measuring station using the translocation of a fluorescence-marked molecule, e.g., receptor activation followed by receptor internalization, receptor activation followed by the bonding of arrestin, receptor aggregation, transition of a molecule from the plasma membrane into the cytosol, from the cytosol into the plasma membrane, from the cytosol into the cell nucleus or from the cell nucleus into the cytosol.

Furthermore, even the interaction of two molecules can be determined in the framework of the main and/or pre-analysis and at least one of the interacting molecules preferably carries a fluorescent marker and the interaction is indicated, e.g., by colocalization-free fluorescent dyes, a FRET or a change in the fluorescence lifetime.

However, even the status of a cell in a cell cycle can be determined in the framework of the main and/or pre-analysis and the morphology of the cell or the coloring of the cellular chromatin is preferably evaluated.

Another possibility for the main and/or pre-analysis is to determine the membrane potential of a cell, during which dyes sensitive to the membrane potential are used. Dyes are preferably used in this instance that are sensitive to the plasma membrane potential and/or to the mitochondrial membrane potential.

Moreover, even the vitality of a cell can be determined in the framework of the main and/or pre-analysis, during which the morphology of the cell is preferably evaluated and/or fluorigenic substances are used that can distinguish between living and dead cells.

Furthermore, even cytotoxic effects can be analyzed and/or the intracellular pH determined during the main and/or pre-analysis.

It is also possible in the framework of the main and/or pre-analysis to determine the concentration of one or several ions in a cell.

Also, an enzymatic activity in a cell can be determined during the main and/or pre-analysis, during which fluorigenic or chromogenic substances, especially kinases, phosphatases or proteases can be used.

Furthermore, the production output of cells that produce biological products such as e.g., proteins, peptides, antibodies, hydrocarbons or fats can be determined in the main and/or pre-analysis, for which one of the described methods can be used.

Finally, even cell stress paths, metabolic paths, cellular growth paths, cell division paths and other signal transduction paths can be determined in the framework of the main analysis in the second measuring station.

However, the invention is not limited to the previously described microfluidic system in accordance with the invention as an individual part but rather also comprises a device, in particular a cell sorter with such a microfluidic system as structural component.

Moreover, the invention also comprises an actuation method for the electrical actuation of the common electrodes in accordance with the desired manipulation function.

Furthermore, it should be mentioned that the concept of a particle used in the context of the invention is to be understood in a general manner and is not limited to individual biological cells but rather this concept also includes synthetic or biological particles. Special advantages result if the particles comprise biological materials, that is, e.g., biological cells, cell groups, cellular components, viruses or biologically relevant macromolecules, optionally in combination with other biological particles or synthetic carrier particles. Synthetic particles can comprise solid particles, liquid particles separated from the suspension medium or multiphase particles that form a separate phase relative to the suspension medium in the carrier flow.

Moreover, it should be mentioned that the electrode arrangements are preferably three-dimensional arrangements. It is also possible that the electrode arrangements were processed only on one channel side; however, it is especially advantageous to arrange the electrode arrangements on two opposing channel walls, wherein only one arrangement can be recognized in the drawings. For example, a funnel can consist of two or four electrodes.

Finally, the invention also comprises the novel use of the microfluidic system in accordance with the invention for investigating and/or sorting particles, in particular of biological cells.

Other advantageous further developments of the invention are characterized in the subclaims or are or are explained in detail in the following together with the description of the preferred exemplary embodiments of the invention using the figures.

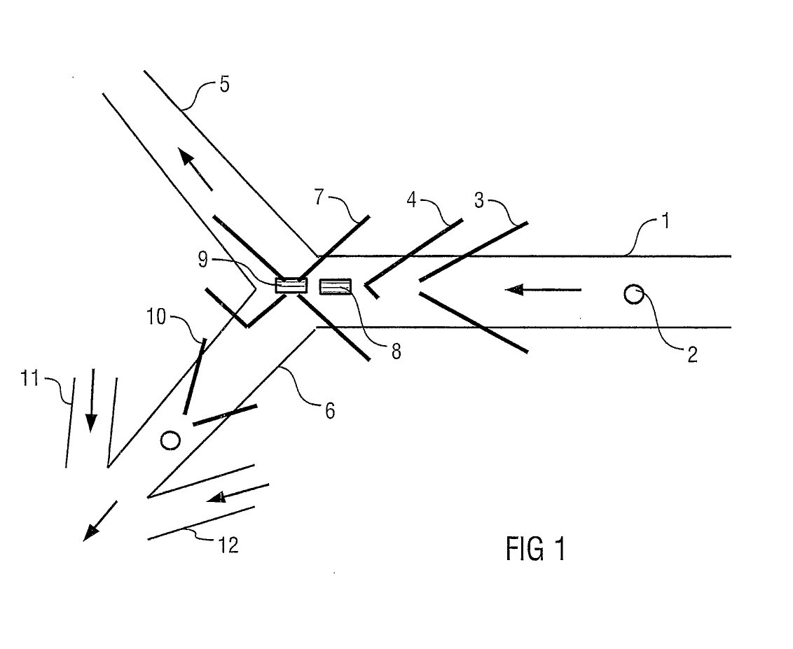

FIG. 1 shows a schematic illustration of a microfluidic system in accordance with the invention.

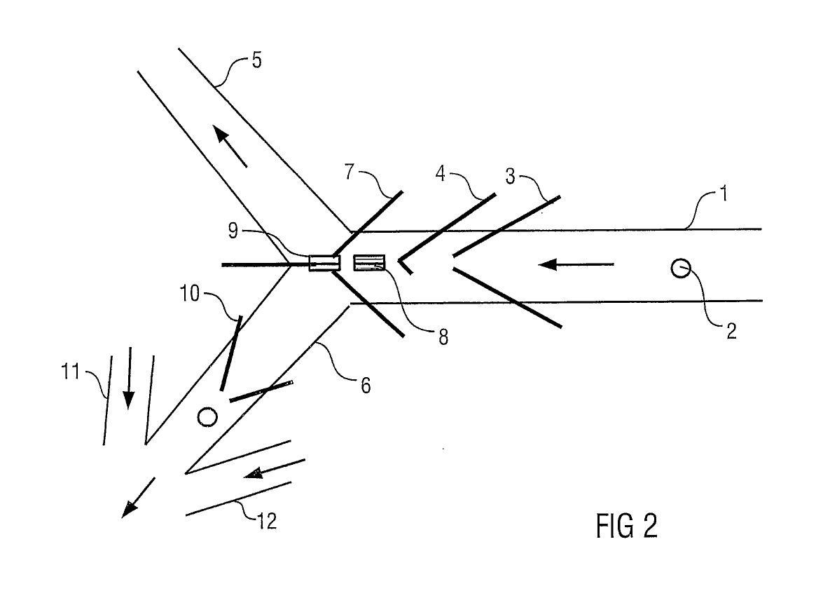

FIG. 2 shows another exemplary embodiment of a microfluidic system in accordance with the invention.

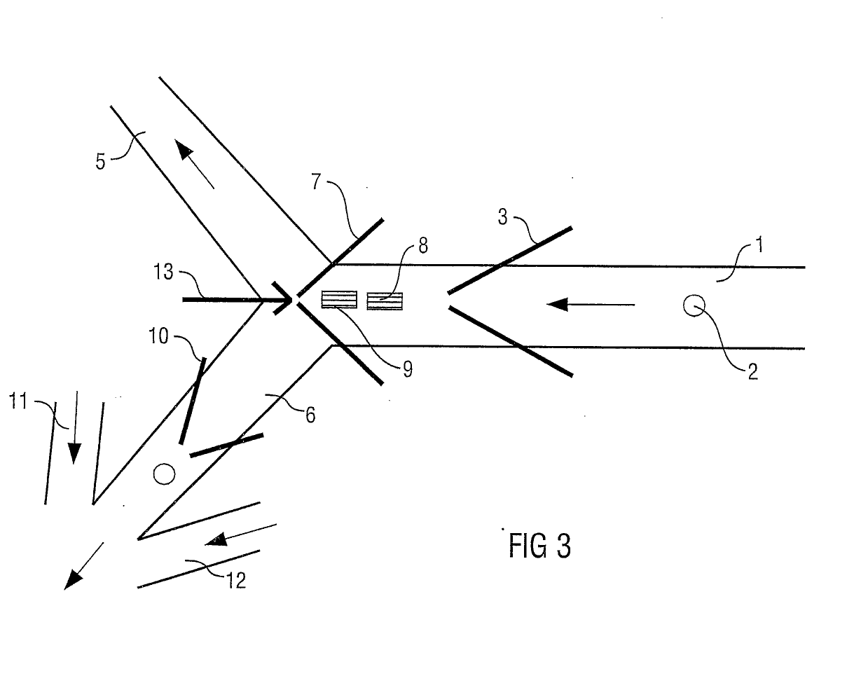

FIG. 3 shows another alternative exemplary embodiment of a microfluidic system in accordance with the invention.

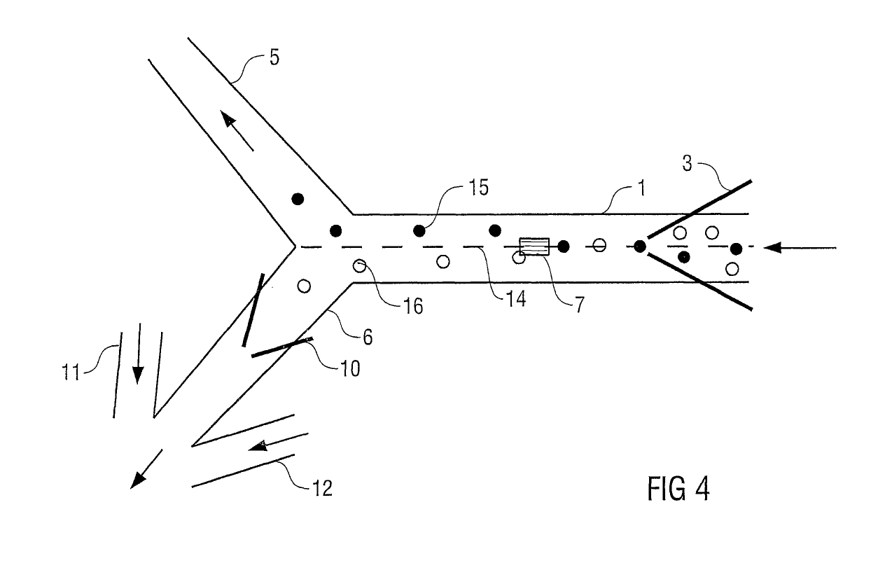

FIG. 4 shows an alternative exemplary embodiment of a microfluidic system in accordance with the invention in which the sorting apparatus is arranged upstream before the branching area.

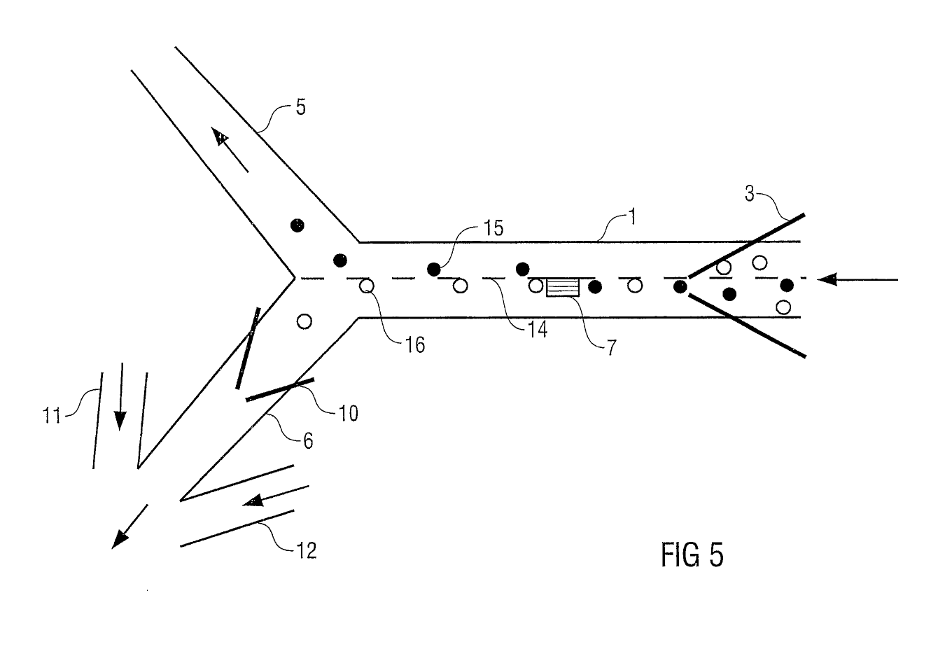

FIG. 5 shows another exemplary embodiment of a microfluidic system in which the sorting apparatus is arranged off-center in the carrier flow channel.

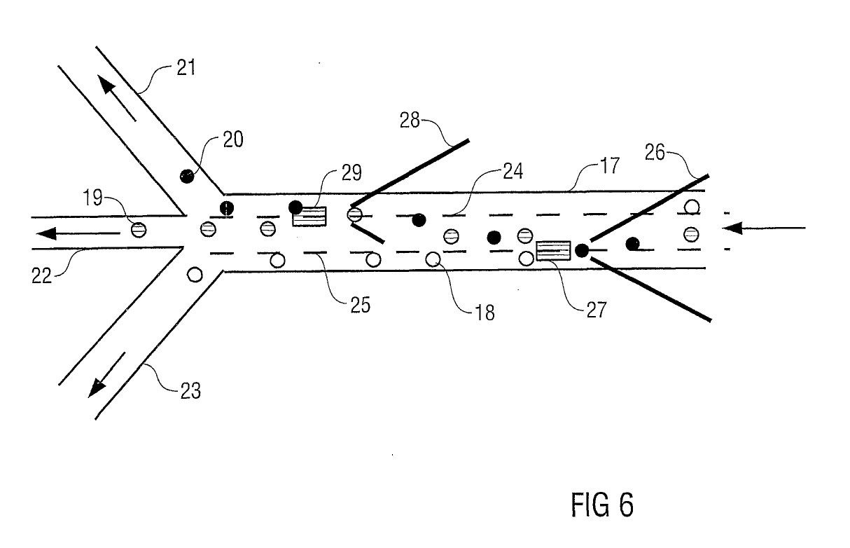

FIG. 6 shows a microfluidic system in accordance with the invention with three outlet conduits.

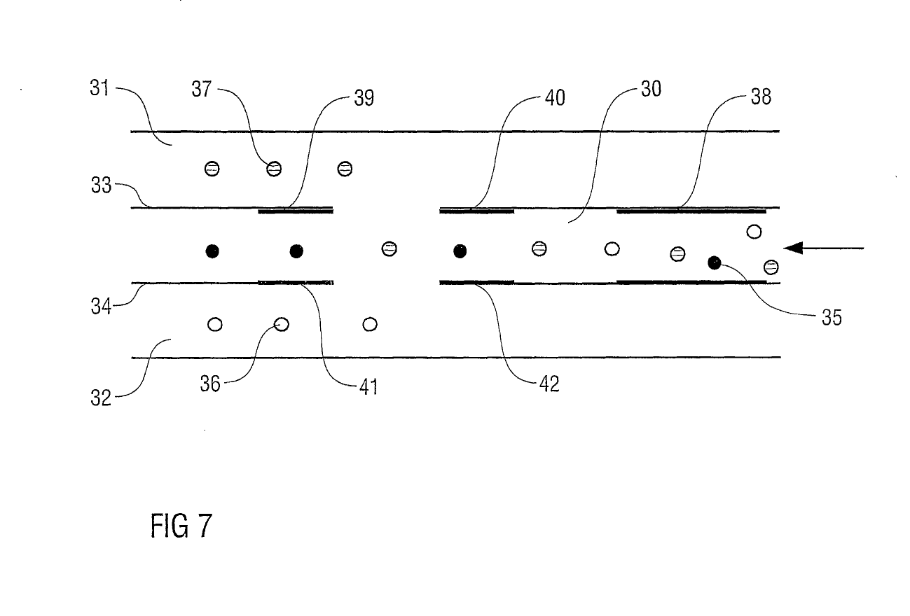

FIG. 7 shows an exemplary embodiment of a microfluidic system with a central carrier flow channel with two adjacent bypass flow channels.

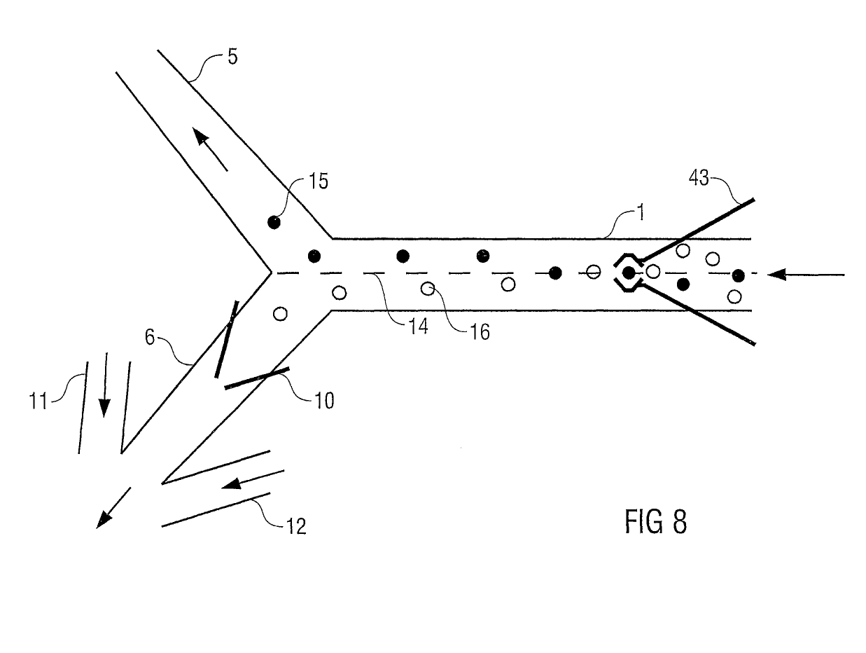

FIG. 8 shows an exemplary embodiment of a common electrode arrangement that integrates a function of a field cage and of a centering apparatus.

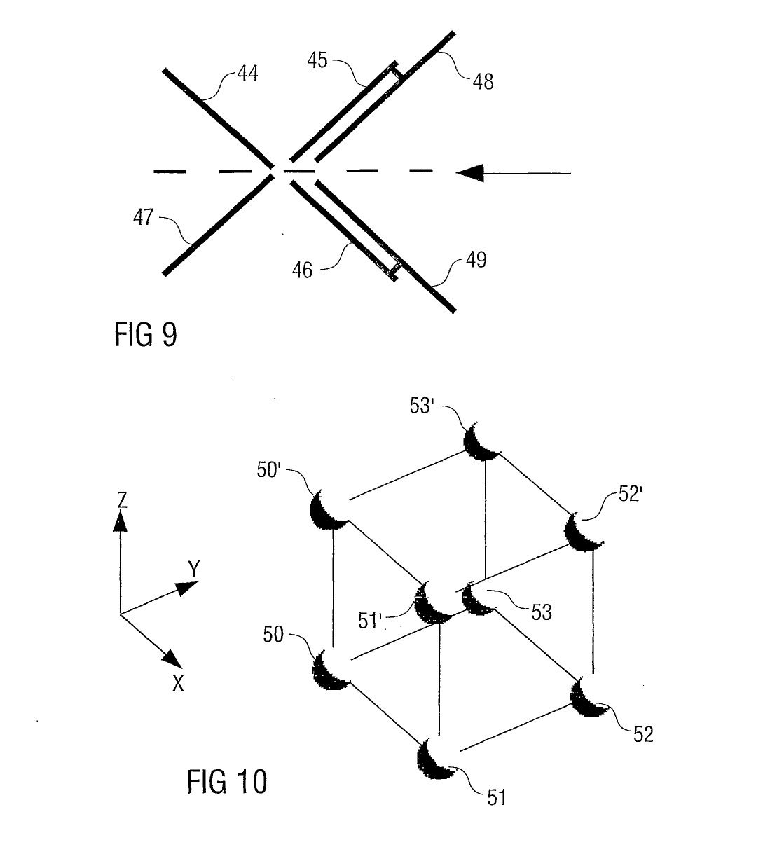

FIG. 9 shows another exemplary embodiment in accordance with the invention with an electrode arrangement that integrates the function of a field cage and of a centering apparatus.

FIG. 10 shows a schematic view of an electrode arrangement in accordance with the invention and

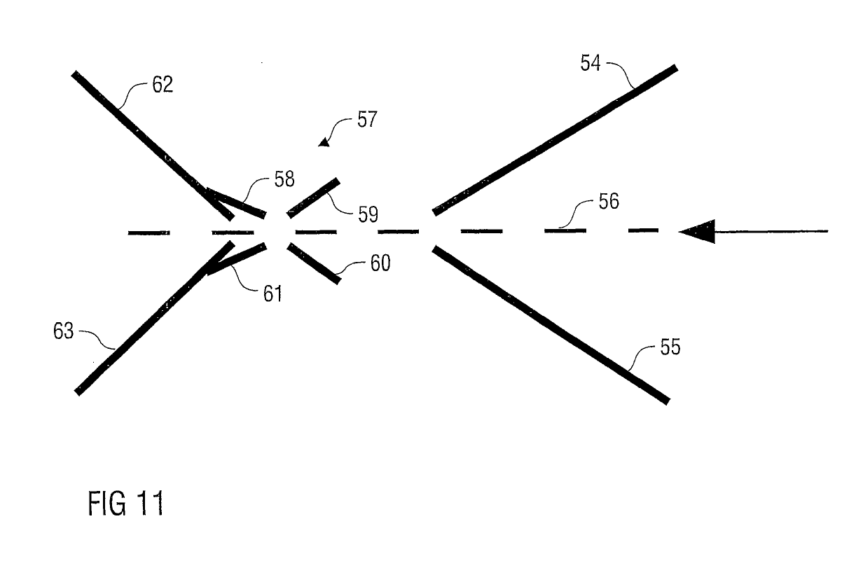

FIG. 11 shows another exemplary embodiment of a microfluidic system in accordance with the invention.

The schematic illustration in FIG. 1 shows a microfluidic system with a carrier flow channel 1 for supplying a carrier flow with particles 2 suspended therein.

A dielectrophoretic electrode arrangement 3 is arranged in the carrier flow channel 1 that centers the particles 2 in the carrier flow and aligns them in series in the direction of flow. The construction and the method of operation of the electrode arrangement 3 is described, e.g., in the already initially cited publication by T. Muller et al.: “A 3-D Microelectrode System for Handling and Caging Single Cells and Particles”, in which the electrode arrangement 3 is designated as a funnel. The content of this publication is therefore to be included to its full extent in the present specification as regards the construction and the method of operation of the electrode arrangement 3.

Another dielectrophoretic electrode arrangement 4 that makes it possible to temporarily park the particles 2 is located in the carrier flow channel 1 downstream after the electrode arrangement 3. The construction and the method of operation of the electrode arrangement 4 are described, e.g., in T. Muller et al.: “Life Cells in Cellprocessors” (Bioworld, 2-2002) in which the electrode arrangement 4 is designated as a hook. The content of this publication is therefore to be included to its full extent in the present specification as regards the construction and the method of operation of the electrode arrangement 4, so that a detailed description of the electrode arrangement 4 can be dispensed with at this point.

Carrier flow channel 1 branches into two outlet conduits 5, 6 downstream after the electrode arrangement 4, another electrode arrangement 7 being arranged in the branching area that can be selectively actuated as a dielectrophoretic field cage or as a particle gate. As regards the construction and the actuation of the electrode arrangement 7 as a particle gate or as a field cage, reference is made to the already initially cited publication by T. Muller et al.: “A 3-D Microelectrode System for Handling and Caging Single Cells and Particles”, whose content is to be included to its full extent in the present specification as regards the shaping of the electrode arrangement 7. Therefore, the electrode arrangement 7 combines the function of two manipulation apparatuses that are separate in the state of the art, namely, on the one hand a function of a dielectrophoretic field cage (cage), and on the other hand a function of a particle gate (sorting gate). In order to select the desired function of the electrode arrangement 7 the individual electrodes of the electrode arrangement 7 merely have to be appropriately actuated, which is already known for the individual separate manipulation apparatuses (cage or sorting gate) from the already initially cited publication of T. Muller et al.

A first measuring station 8 that carries out a pre-analysis of the particles 2 suspended in the carrier flow is located between the electrode arrangements 4 and 7 in the carrier flow channel 1. The pre-analysis can take place in the initially described manner.

The electrode arrangement 7 can be connected either as a field cage or as a particle gate depending on the result of the pre-analysis. The electrode arrangement 7 is in the gate operating mode at first.

If the result of the analysis in the measuring station 8 shows, e.g., that analyzed the particle 2 is no longer interesting, this particle 2 is transported into an outlet conduit 5 for uninteresting particles. On the other hand, if the analysis in the measuring station 8 shows that the particle 2 satisfies the measuring criteria of the pre-analysis, the electrode arrangement 7 is connected as a field cage so that the particle 2 can be subsequently analyzed in the fixed state in the electrode arrangement 7 by a second measuring station 9, the second measuring station 9 making a detailed analysis of the particle 2, as has already been described initially. According to the result of the measuring at the measuring station 9, the electrode arrangement 7 can be subsequently connected as a sorting gate (see FIG. 10 and the associated description) and the particle transferred into one of the outlet conduits 5 (negative), 6 (positive).

Furthermore, the electrode arrangement 10 is arranged in the outlet conduit 6 for the positively selected particles 2 that centers the particle 2 in the outlet conduit 6 and thus prevents the particle 2 from dropping down in the outlet conduit 6.

Finally, it should also be mentioned that two casing flow conduits 11, 12 empty into the outlet conduit 6, which is also known.

The alternative exemplary embodiment shown in FIG. 2 largely corresponds to the previously described exemplary embodiment shown in FIG. 1 so that in order to avoid repetitions, reference is made to the previous description, the same reference numerals being used for corresponding structural components.

This exemplary embodiment has the particularity that the electrode arrangement 7 has only six spatially arranged electrodes that can, however, also be selectively connected as a field cage or as a particle gate.

Finally, the alternative exemplary embodiment shown in FIG. 3 also corresponds largely with the previously described exemplary embodiment shown in FIG. 1 so that in order to avoid repetitions, broad reference is made to the previous description, the same reference numerals being used in the following for corresponding structural components.

This exemplary embodiment has the particularity that the electrode arrangement 7 has an arrow electrode 13 that is aligned in opposite direction to the direction of flow and is permanently actuated, two deflection electrodes bordering on the arrow electrode 13 and being individually actuated for deflecting into the desired outlet conduit 5 or 6. This configuration is also designated as “Ultra Fast Sorter” and makes possible a rapid sorting of the suspended particles 2.

The alternative exemplary embodiment shown in FIG. 4 largely corresponds to the previously described exemplary embodiments 1 so that in order to avoid repetitions, broad reference is made to the previous description, the same reference numerals being used for corresponding structural components and only the particularities of this exemplary embodiment are described.

This exemplary embodiment has the particularity that the electrode arrangement 7 is arranged in the carrier flow channel 1 upstream before the branching area of the two outlet conduits 5, 6. An areal dividing line 14 runs centrally in the carrier flow channel 1, wherein the particles 15 shown in black in the drawing flow into the outlet conduit 5 for negatively selected particles and on the other hand the particles 16 shown in a contour line in the drawing flow into the other outlet conduit 6 for positively selected particles. The dividing line 14 is also designated as the separatrix and separates two partial flows in the carrier flow channel 1 that flow without an actuation of the electrode arrangement 7 as particle gate into the particular associated upper or lower outlet conduit 5 or 6. In order to achieve a defined sorting of the particles 15, 16 onto the two outlet conduits 5, 6 the common electrode arrangement 7 must therefore be actively and constantly actuated as a particle gate.

The alternative exemplary embodiment of a microfluidic system shown in FIG. 5 largely corresponds to the previously described exemplary embodiment shown in FIG. 4 so that broad reference is made to the previous description, the same reference numerals being used in the following for corresponding structural components.

This exemplary embodiment has the particularity that the common electrode arrangement 7 that can be selectively actuated as a particle gate or as a field cage is arranged off-center in the carrier flow channel 1. This means that the electrode arrangement 7 is located relative to the direction of flow in the carrier flow channel 1 laterally next to dividing line 14 on the side of the outlet conduit 6. This means that the particles 15, 16 flow independently into the outlet conduit 6 if the electrode arrangement 7 is not actively actuated as particle gate in order to deflect the particles 15 past the dividing line 14 onto the other side of the carrier flow channel 1. This exemplary embodiment is therefore advantageous if the amount of the particles 15 to be negatively selected is substantially smaller than the amount of the particles 16 to be positively selected since an actuation of the electrode arrangement 7 is necessary only for sorting out the relatively small number of the particles 15 to be negatively selected.

FIG. 6 shows another exemplary embodiment of a microfluidic system with a carrier flow channel 17 for supplying a carrier flow with particles 18, 19, 20 suspended therein, the particles 18, 19, 20 being different, which is indicated in the drawings by the different graphical representation of the particles 18, 19, 20.

The carrier flow channel 17 branches downstream into three outlet conduits 21, 22, 23 for receiving and removing the different particles 18, 19, 20. The outlet conduit 21 serves here to receive the particles 20 sketched in black whereas the outlet conduit 22 serves to remove the particles 19 shown with shading, in contrast to which the outlet conduit 23 receives and removes the particles 18 sketched as a contour line.

Two (imaginary) dividing surfaces or areal dividing lines 24, 25 run in the carrier flow channel 17 that the limit three partial flows in the carrier flow channel 17 and form dividing lines 24, 25 in the top view shown.

The particles suspended in the upper partial flows above the dividing line 24 pass independently in this instance into the outlet conduit 21 in as far as these particles are not actively deflected, as will be described in the following in detail.

In contrast thereto, the particles suspended in the carrier flow between the two dividing lines 24, 25 pass independently without an external deflection into the outlet conduit 22.

Furthermore, the particles suspended in the carrier flow below the dividing line 25 flow independently into the outlet conduit 23 as far as these particles are not actively deflected, as will be described in detail.

A centering apparatus 26, that aligns the particles 18, 19, 20 suspended in the carrier flow on the dividing line 25 and feeds them to the following electrode arrangement 27, is located upstream in the carrier flow channel 17 at first. An electrode arrangement 27 combines the function of a field cage with the function of a deflection apparatus (sorting gate).

When actuated as a field cage, the electrode arrangement 27 can fix the particles 18, 19 and 20 in order that the particles 18, 19, 20 are analyzed by a measuring station that is not shown for the sake of simplification.

On the other hand, when actuated as a particle gate or deflection apparatus, the electrode arrangement 27 can either allow the particles 18, 19, 20 to flow further straight ahead or deflect them laterally into the partial flow between the two dividing lines 24, 25 as a function of the result of the previous analysis.

Another centering apparatus 28 is located downstream after the electrode arrangement 27, which centering apparatus 28 is arranged off-center in the carrier flow channel 17 and aligns the particles suspended in the two partial flows on both sides of the dividing line 24 on the dividing line 24 and supplies them to another electrode arrangement 29 that can be selectively actuated as a field cage or as a particle gate.

When the electrode arrangement 29 is actuated as a field cage, the electrode arrangement 29 can fix the particles 19 and 20 in order that they can be analyzed by a measuring station that is not shown for the sake of simplification.

When actuated as particle gate the electrode arrangement can deflect the particles selectively into the partial flow located above the dividing line 24 or into the partial flow located below the dividing line 24 in order that the particles flow in the desired outlet conduit 21 or 22. The actuatuation of the electrode arrangement 29 as particle gate for sorting the particles onto the two outlet conduits 21, 22 takes place here as a function of the result of the previous analysis of the measuring station (not shown).

The electrode arrangements 27, 29 can additionally assume, like in FIG. 9 in an alternative embodiment, the function of the centering apparatus 26, 28, which can eliminate these elements placed in front.

FIG. 7 shows a lateral view of another exemplary embodiment of a microfluidic system with a carrier flow channel 30 and two adjacent bypass flow channels 31, 32, the two bypass flow channels 31, 32 each being separated from the carrier flow channel 30 by a dividing wall 33, 34.

Suspended particles 35, 36, 37 are supplied via the carrier flow channel 30 to the microfluidic system, the particles 35, 36, 37 being different and being distributed accordingly onto the two bypass flow channels 31, 32 or onto carrier flow channel 30, which runs further.

At first, the electrode arrangement 38 is located in the carrier flow channel 30 at its upstream end for aligning the particles 35, 36, 37 centrally in the carrier flow channel 30.

Each of the dividing walls 33, 34 have an opening downstream after the electrode arrangement 8 through which the particles 35, 36, 37 can be deflected into adjacent bypass the flow channels 31, 32. To this end an electrode arrangement is arranged in the area of the openings that can be selectively actuated as a field cage or as a particle gate, this common electrode arrangement consisting of eight electrodes of which only four electrodes 39, 40, 41, 42 can be recognized here.

When the common electrode arrangement is actuated as a field cage, the particles 35, 36, 37 can be fixed in the field cage in order to make a detailed analysis possible by a measuring station that is not shown for the sake of simplification.

As a function of the result of this analysis the common electrode arrangement can then be actuated as a particle gate in order to transport the particles 37 into bypass flow channel 31 and to deflect the particles 36 into the bypass flow channel 32.

In addition, the particles can also be conducted as described in FIG. 1 by the eight-electrode arrangement into different flow paths (in the plane shown as well as before it or behind it) of the channel 30, 31 and 32 and addressed therewith up to 9 different fluidic outlets (for fractionation).

The exemplary embodiment of a microfluidic system shown in FIG. 8 broadly corresponds to the previously described exemplary embodiment shown in FIG. 4 so that in order to avoid repetitions, broad reference is made to the previous description, the same reference numerals being used for corresponding structural components.

This exemplary embodiment has the particularity that the functions of the electrode arrangements 3 and 7 in FIG. 4 are integrated in this exemplary embodiment in a single electrode arrangement 43 that can be selectively actuated as a centering apparatus (funnel), as a field cage or as a particle gate (sorting gate).

The electrode arrangement 43 has electrodes that run toward each other in the direction of flow, the end points of these electrodes being formed convexly, e.g., in a semicircular shape. The electrode arrangement 43 can also hold particles with the aid of this special shaping.

Furthermore, FIG. 9 shows a schematic illustration of a common electrode arrangement that can be selectively actuated as a centering apparatus or as a field cage. To this end the electrode arrangement has eight cage electrodes arranged like an ashlar, of which only four cage electrodes 44, 45, 46, 47 are recognizable in the top view.

Moreover, four traditionally arranged deflection electrodes are provided here of which only two deflection electrodes 48, 49 are recognizable in the top view.

The cage electrodes 45, 47 located upstream are each electrically connected to one of the two deflection electrodes 48, 49 and can be actuated in common with them.

Table 1 lists potential actuation possibilities for the electrode arrangement shown in FIG. 9, in particular red, AC I and AC II mode.

Red and ACI mode are suited for trapping the particles in the field cage as well as for aligning the particles. The red mode having the advantage that it prevents the entering of particles into the cage substantially more effectively than the AC I mode.

In an alternative embodiment of the electrode arrangement shown in FIG. 9 one of the electrode (pairs) 49, 48 is lengthened on the downstream point and designed as a hook over the central line. The other electrode pair is offset upstream or can also be eliminated in another possible embodiment. This allows an intermediate storage of the particles to be additionally realized before the actual cage in the red and AC I modes.

The AC II mode is distinguished by an especially stable holding (without rotation) of the particles and is therefore especially suitable for high-resolution measurements.

In order to realize a holding of the particles the following arrangement is to be used: Each electrode of the described pair of electrodes (48, 49) is designed to be lengthened in a hook shape in different planes. This ensures a hook function in the red and AC II modes. If the aligning function can be eliminated the shorter straight counterelectrode (48, 49) can be dispensed with in this embodiment.

Finally, FIG. 10 shows a schematic view of the geometric arrangement of eight cage electrodes 50, 50′, 51, 51′, 52, 52′, 53, 53′ in which the direction of flow runs in the Y direction.

The electrical actuation of the individual cage electrodes 50, 50′, 51, 51′, 52, 52′, 53, 53′ is described, e.g., in the already initially cited publication of T. Muller at al.: “A 3-D Microelectrode System for Handling and Caging Single Cells and Particles”, the content of which is to be included to its full extent in the present specification. In order to release a trapped particle in the Y direction, the cage electrodes 52, 52′, 53, 53′ are sufficiently weakened, which can take place, e.g., by cutting out these cage electrodes. An analogous treatment applies to the X and Y direction. A weakening of the electrodes 52, 52′ results in the escaping of the particle in the XY direction (1,1,0 direction). If, on the other hand, only the electrode 52′ is weakened, the trapped particle leaves the field cage in the 1,1,1 direction. An especially rapid particle escape (catapult mode) can be achieved in that the voltage is increased and/or the phase position altered on at least one further electrode (e.g., the opposite electrode).

In an analogous manner a particle can also be let into the cage in a defined manner or pass through defined trajectories, wherewith even sorting gate functions of the cage can be realized. This is described by way of example in the following. The actuation types known from T. Muller et al.: “A 3-D Microelectrode System for Handling and Caging Single Cells and Particles” comprise rotational modes and AC field modes that are reproduced in table 1 with reference made to the electrode designations in FIG. 10. These modes can trap particles in the cage and release them in a defined direction, as described above. Moreover, exemplary sorting gate modes are indicated that deflect particles flowing in from the Y direction into the XY direction and/or XY direction.

TABLE 1
Exemplary phase positions for actuation modes of an octode field cage

| | 50 | 51 | 52 | 53 | 50′ | 51′ | 52′ | 53′ |
|---|---|---|---|---|---|---|---|---|
| Red | 0° | 90° | 180° | 270° | 180° | 270° | 0° | 90° |
| AC I | 0° | 180° | 0° | 180° | 180° | 0° | 180° | 0° |
| AC II | 0° | 180° | 0° | 180° | 0° | 180° | 0° | 180° |
| Sorting gate in (1, 1, 0) | 0° | Ground | 90° | Ground | 270° | Ground | 180° | Ground |
| Sorting gate in (−1, 1, 0) | Ground | 0° | Ground | 90° | Ground | 270° | Ground | 180° |

Finally, FIG. 11 shows another exemplary embodiment of a microfluidic system in accordance with the invention, a carrier flow with particles suspended in it flowing in the direction of the arrow.

At first, several electrodes 54, 55 are arranged in a funnel-shaped are arranged in the upstream area of the microfluidic system that center the particles suspended in the carrier flow on a center line 56.

An electrode arrangement 57 is located downstream behind the electrodes 54, 55 and serves to trap the particles and to rapidly switch them into two flow paths. The electrode arrangement 57 has a field cage on its upstream end that consists of several electrodes 58-61. Furthermore, the electrode arrangement 57 comprises several deflection electrodes 62, 63 on both sides of the center line 56 that deflect the particles upon a corresponding actuation into one of two flow paths. The deflection electrodes 62, 63 are connected galvanically to the electrodes 58, 61 of the field cage.

The invention is not limited to the previously described preferred exemplary embodiments but rather a plurality of variants and modifications is possible that also make use of the concept of the invention and therefore fall into its protective scope.

### LIST OF REFERENCE NUMERALS

1 carrier flow channel
2 particle
3 electrode arrangement
4 electrode arrangement
5 outlet conduit
6 outlet conduit
7 electrode arrangement
8 measuring station
9 measuring station
10 electrode arrangement
11 casing flow conduit
12 casing flow conduit
13 arrow electrode
14 dividing line
15 particles
16 particles
17 carrier flow channel
18 particles
19 particles
20 particles
21 outlet conduit
22 outlet conduit
23 outlet conduit
24 dividing line
25 dividing line
26 centering apparatus
27 electrode arrangement
28 centering apparatus
29 electrode arrangement
30 carrier flow channel
31 bypass flow channel
32 bypass flow channel
33 dividing wall
34 dividing wall
35 particles
36 particles
37 particles
38 electrode arrangement
39 electrode
40 electrode
41 electrode
42 electrode
43 electrode arrangement
44 cage electrode
45 cage electrode
46 cage electrode
47 cage electrode
48 deflection electrode
49 deflection electrode
50, 50′ cage electrode
51, 51′ cage electrode
52, 52′ cage electrode
53, 53′ cage electrode
54, 55 electrodes
56 center line
57 electrode arrangement
58-61 electrodes
62, 63 deflection electrode

1-24. (canceled)

25. A microfluidic system, comprising:
a) at least one carrier flow channel for supplying a carrier flow with particles suspended therein,
b) a plurality of outlet conduits,
c) a branching area in which the carrier flow channel branches into the outlet conduits,
d) a first manipulation apparatus arranged in the carrier flow channel for the manipulation of the particles suspended in the carrier flow, the first manipulation apparatus being a field cage that fixes the particles, and
e) a second manipulation apparatus arranged in the carrier flow channel for the manipulation of the particles suspended in the carrier flow, the second manipulation apparatus being a particle gate that sorts the particles suspended in the carrier flow into one of the outlet conduits,
wherein the first manipulation apparatus and the second manipulation apparatus have a common electrode arrangement and the common electrode arrangement is arranged in the branching area.

26. The microfluidic system according to claim 25, wherein the common electrode arrangement additionally forms a third manipulation apparatus.

27. The microfluidic system according to claim 25, wherein the common electrode arrangement has at least one electrode that is a component of the first manipulation apparatus as well as a component of the second manipulation apparatus.

28. The microfluidic system according to claim 26, wherein the third manipulation apparatus is a centering apparatus that centers the particles in the carrier flow channel.

29. The microfluidic system according to claim 25, wherein
the electrode arrangement includes at least one arrow-shaped electrode and a plurality of deflection electrodes,
the at least one arrow-shaped electrode is aligned in opposite direction to a direction of flow of the carrier flow, and
the deflection electrodes are arranged upstream before the at least one arrow-shaped electrode and border on the at least one arrow-shaped electrode.

30. The microfluidic system according to claim 25, wherein
the electrodes of the electrode arrangement can be separately actuated, and
the electrode arrangement has a number of electrodes selected from the group consisting of four, six or eight electrodes.

31. The microfluidic system according to claim 25, wherein the field cage comprises eight electrodes and the centering unit comprises four electrodes, provided that four electrodes of the field cage are located upstream of and electrically connected to one of the four electrodes of the centering unit.

32. The microfluidic system according to claim 25, wherein a first measuring station in which the particles suspended in the carrier flow are analyzed in the flowing state upstream from the common electrode arrangement.

33. The microfluidic system according to claim 25, wherein a second measuring station that analyzes the particles fixed in the field cage.

34. The microfluidic system according to claim 25, wherein an actuation unit for actuating the common electrode arrangement, the actuation unit being connected on the input side to the first measuring station and/or to the second measuring station and actuates the common electrode arrangement as a function of the analysis in the first measuring station and/or in the second measuring station.

35. A particle sorter with a microfluidic system according to claim 25.

36. An actuation method for an electrode arrangement arranged in a carrier flow channel of a microfluidic system, wherein in the carrier flow channel a carrier flow with suspended particles flows, said method comprising the following steps:
a) electrical actuation of the electrode arrangement so that the particles suspended in the carrier flow are subjected by the electrode arrangement to a first manipulation, the first manipulation comprising a fixation of the suspended particles, and
b) selective actuation of the electrode arrangement for carrying out the first manipulation on the particles or for carrying out a second manipulation on the particles,
wherein the second manipulation comprises a sorting of the suspended particles and the common electrode arrangement is arranged in a branching area in which the carrier flow channel branches into outlet conduits.

37. The actuation method according to claim 36, wherein the particles suspended in the carrier flow are analyzed.

38. The actuation method according to claim 37, wherein the electrode arrangement is actuated as a function of an analysis of the particles for carrying out the first manipulation and/or the second manipulation.

39. A method for analyzing particles, said method comprising the use of a microfluidic system according to claim 25.

40. A method for sorting particles, said method comprising the use of a microfluidic system according to claim 25.
